(19) United States
(12) Patent Application Publication
(10) Pub. No.: US 2002/0176372 A1
(43) Pub. Date: Nov. 28, 2002

(54) Broadcast receiver

(76) Inventors: Tetsuya Ichikawa, Iwaki-city (JP); Takahiro Fukushima, Iwaki-city (JP)

Correspondence Address: BRINKS HOFER GILSON & LIONE, P.O. BOX 10395, CHICAGO, IL, 60611, US

(21) Appl. No.: 10/144,675

(22) Filed: May 13, 2002

(30) Foreign Application Priority Data
May 15, 2001 (JP) 2001-144409

(51) Int. Cl. H04L 12/28

(52) U.S. Cl. 370/254

(57) ABSTRACT

A receiver is provided for efficiently selecting a channel providing desired broadcast information. The broadcast information of each channel transmitted from a digital broadcast has been given a plurality of categories having different priority levels. When a channel search is instructed with a category to be searched for as a specified target, a controller performs the channel search for a channel having a category matching the category to be searched for as a target in order of precedence of the categories. After the channel having the matching category is found, the controller receives the broadcast information of the channel as a new channel.

### BACKGROUND OF THE INVENTION

1. Field of the Invention

The present invention relates to receivers for receiving various types of digital broadcast.

2. Description of the Related Art

Currently, various types of digital broadcast, in which video signals and audio signals are converted to digital form, have become commercially practical. The digital broadcast such as the communication satellite (CS) digital broadcast, the broadcasting satellite (BS) digital broadcast, and the digital audio broadcasting (DAB) in Europe, are put into practical use to provide video broadcast and audio broadcast of high quality. Generally, a digital broadcasting system makes use of radio waves more effectively than an analog broadcasting system so that the digital broadcasting system can multiplex many channels to one broadcast wave. Thus, a digital broadcasting system can receive more channels than the conventional analog broadcasting system, to thereby provide the so-called multi-channel broadcast.

In the above-mentioned types of digital broadcasting system accompanied by the multi-channel broadcast, broadcast information of each channel has been given predetermined category information indicating the contents thereof. Most of the digital broadcast receivers have a function of performing a channel search based on the category information. According to such a search function, a user has only to specify a desired category, making it possible to select from many channels a channel that is supposed to provide the desired broadcast information.

The contents of the category information given to the broadcast information are generally set by broadcast providers. As a result, the contents of the category information do not always reflect the contents of the broadcast information of each channel properly. For this reason, there is a problem that in the conventional receiver, when specifying a category and then performing the channel search, it is difficult for the user to effectively select a channel that provides his/her desired broadcast information.

FIG. 6 is an explanatory diagram showing an example of the channel search based on the category information in a conventional receiver. As shown in FIG. 6, the broadcast information of each channel has been given a channel theme, and a plurality of category information (in this example, three categories). For instance, channel 10 (CH10) has been provided with the channel theme “world sports”, and three pieces of category information, namely, category 1 “sports”, category 2 “entertainment”, and category 3 “nothing”. Furthermore, these pieces of category information each have different priority levels. Category 1 has the highest priority. Category 1, category 2, and category 3 are listed in order of decreasing precedence.

However, in the conventional receiver, when specifying the category and then performing the channel search, the priority levels given to the category information are not considered at all. For instance, while the receiver is receiving channel 10, suppose “pops” is specified as the category and then performing a channel search is instructed and begun in order of increasing channel numbers. Channel 12 is selected as a new channel to be received because category 3 of channel 12 has the category information “pops.” The category information of category 3, however, has the lowest priority, resulting in that the broadcast information of channel 12 fails to include the user's desired contents of “pops.”

Further, in the conventional receiver, when specifying the category and then performing the channel search, the priority levels of categories are not considered, thus making it difficult to effectively select a proper channel. For example, suppose the category information is set as shown in FIG. 6, “entertainment” is specified as the category, the channel search is performed, and then a list of the search result is displayed. In this case, all channels 10 to 13 are displayed on the list regardless of the priority levels of the categories associated with each channel, resulting in that the list fails to satisfy the user's need. In addition, the list does not display the priority level of the category “entertainment” on each channel. For that reason, when the user selects the channel based on the list, the broadcast information of the selected channel possibly does not match the user's desired one.

### SUMMARY OF THE INVENTION

The present invention has been accomplished in view of the above-mentioned technical background, and it is an object of the present invention to provide a receiver that can efficiently select a channel providing desired broadcast information.

To solve the foregoing problems, in a receiver according to the present invention, a receiving means receives broadcast information corresponding to a plurality of categories having different priority levels. Upon entering a category to be searched for as a target by an inputting means, a searching means searches for the broadcast information corresponding to the entered category, considering the priority levels. According to the present invention, a search for the broadcast information is performed considering the priority levels, thus making it possible to efficiently select a channel providing the desired broadcast information.

Preferably, the above-mentioned searching means searches through the plurality of categories corresponding to the broadcast information in order of precedence of the categories, and determines whether the searched category matches the category entered by the input means. The searching means searches for the broadcast information in order of decreasing precedence, to thereby immediately select the channel that provides the desired broadcast information.

Preferably, the receiver further comprises a search result displaying means for displaying a list of a search result given by the search means in order of the precedence of the categories. Thus, by displaying the list of the search result in order of the precedence, many channels are able to be compared with each other considering the priority levels, whereby the desired channel can be selected with reliability.

### BRIEF DESCRIPTION OF THE DRAWINGS

FIG. 1 is a schematic diagram of one preferred embodiment of a receiver according to the present invention.

FIG. 2 is a flow diagram showing the operation of a receiver upon performing a channel search based on a specified category, according to the present invention.

FIG. 3 is a diagram showing one example of category information associated with broadcast information of each channel, according to the present invention.

FIG. 4 is a flow diagram showing the operation of a receiver upon displaying a result list of a channel search and performing a channel selection, according to the present invention.

FIG. 5 is a diagram showing one example of a channel list according to the present invention.

FIG. 6 is an explanatory diagram showing one example of a channel search based on category information in a conventional receiver.

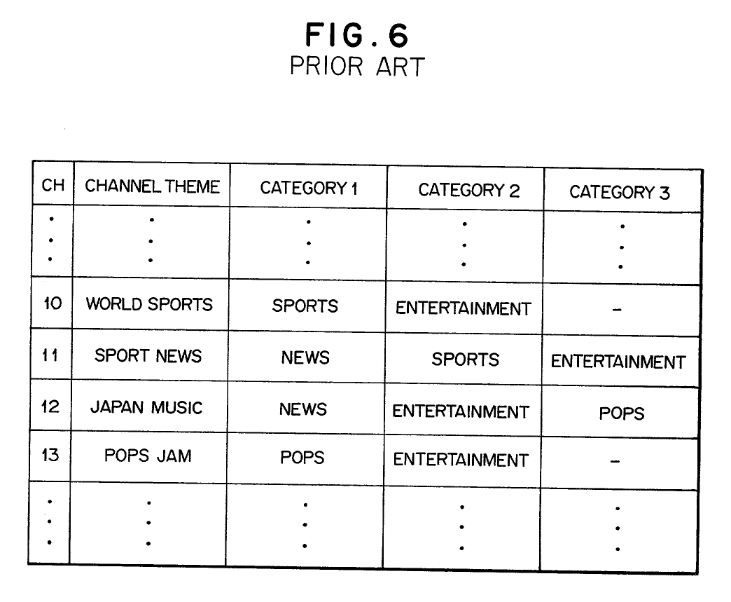

### DESCRIPTION OF THE PREFERRED EMBODIMENTS

A receiver according to an embodiment of the present invention will be described in detail hereinafter with reference to the drawings.

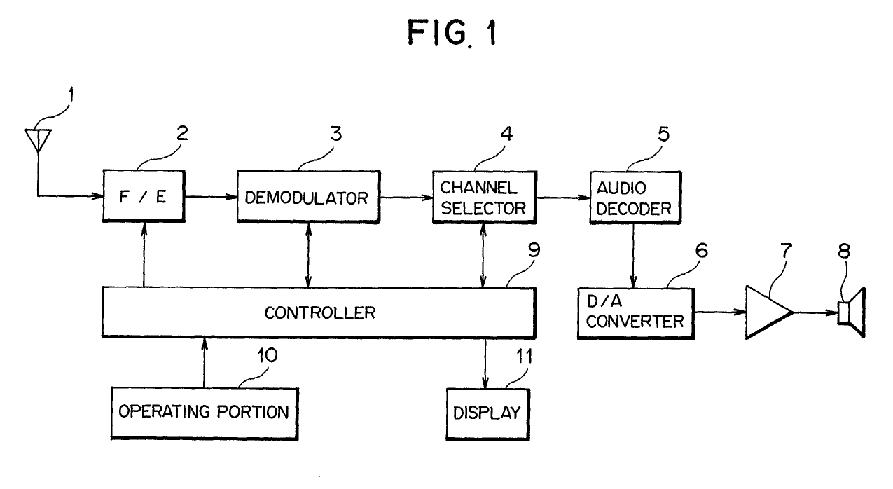

FIG. 1 shows the structure of a receiver according to one embodiment of the present invention. The receiver is for receiving a digital audio broadcast. Referring to FIG. 1, the receiver includes an antenna 1, a front end portion (F/E) 2, a demodulator 3, a channel selector 4, an audio decoder 5, a digital-analog (D/A) converter 6, an amplifier 7, a speaker 8, a controller 9, an operating portion 10, and a display 11.

The front end portion 2 extracts a desired receiving frequency (tuning frequency) component from a broadcast wave received by the antenna 1 and then frequency-converts the extracted signal into an intermediate frequency signal to output it.

The demodulator 3 converts the intermediate frequency signal generated by the front end portion 2 to digital form, and then performs a predetermined demodulating process to demodulate the transmitting data.

The channel selector 4 extracts audio information of a desired broadcast channel from the transmitting data generated by the demodulator 3 based on an instruction from the controller 9, to provide the audio information to the audio decoder 5.

The audio decoder 5 generates audio data by performing predetermined decompression on the audio information generated by the channel selector 4.

The digital-analog converter 6 converts the audio data provided by the audio decoder 5 into an analog signal.

The amplifier 7 amplifies the analog signal, which is generated by the digital-analog converter 6, by a predetermined gain to provide it to the speaker 8. The speaker 8 produces audio corresponding to the amplified analog signal.

The controller 9 is for controlling the entire operation of the receiver of the embodiment. For instance, the controller 9 performs a channel selection of a desired channel, a channel search for a channel providing the broadcast information corresponding to the specified category, and the like.

The operating portion 10 includes various kinds of keys by which the user instructs an operation such as the channel selection, the specification of the category, and provides to the controller 9 a signal corresponding to the state of the operated keys.

The display 11 displays a channel name or a category of the currently received channel, or an operation state of the operating portion 10 as operated by the user.

The above-mentioned antenna 1, front end portion 2, demodulator 3, channel selector 4, and controller 9 correspond to the receiving means; the operating portion 10 corresponds to the inputting means; the controller 9 also corresponds to the searching means; and the controller 9 and the display 11 correspond to the search result displaying means.

Next, the operation of the receiver of an embodiment having the above-mentioned configuration will be described.

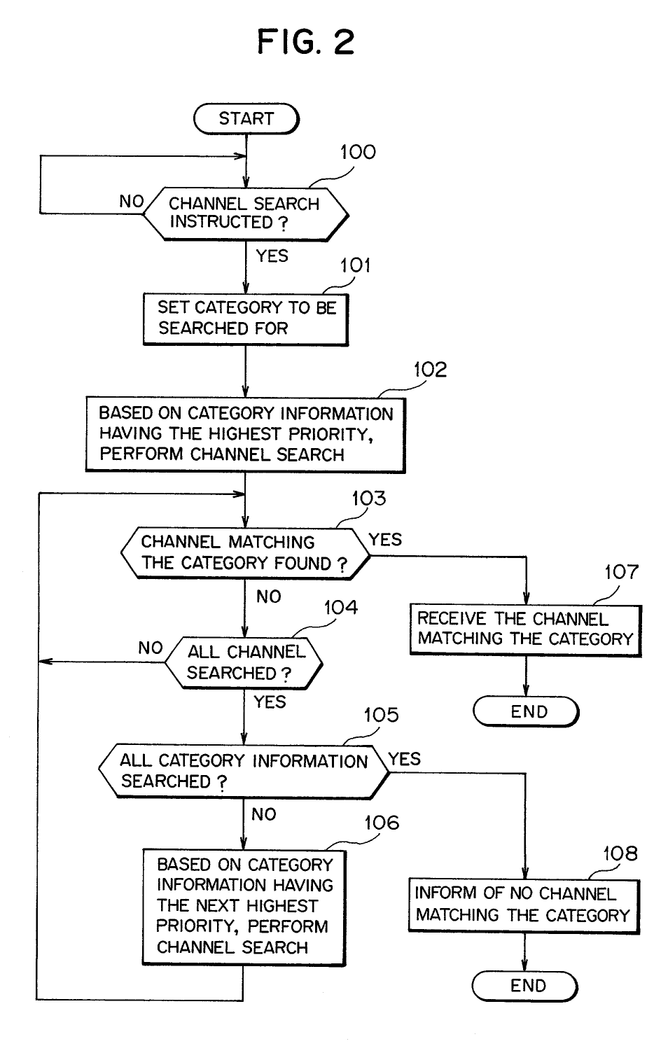

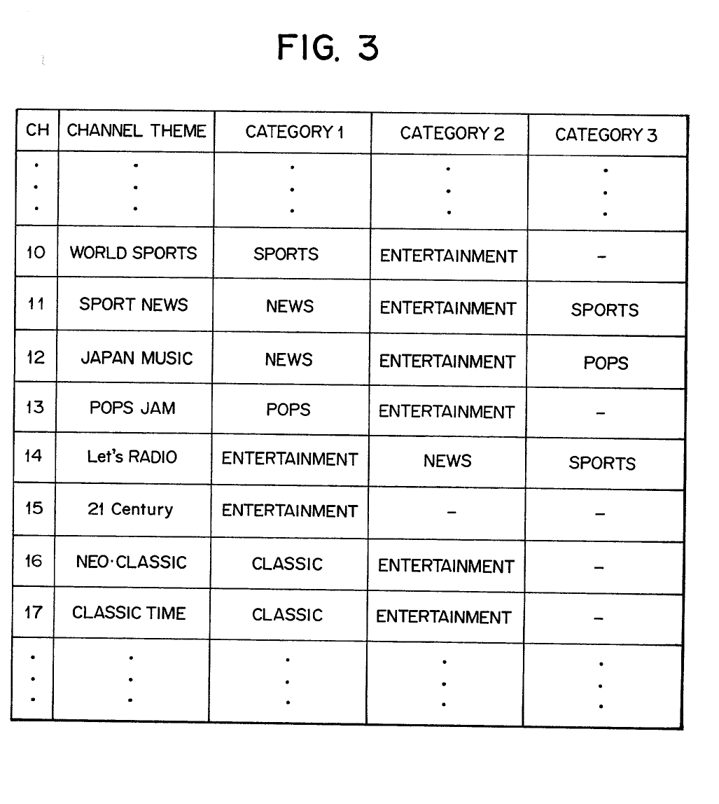

FIG. 2 is a flow diagram showing the operation of the receiver conducting a channel search based on a specified category, and FIG. 3 is a diagram showing one example of category information associated with the broadcast information of each channel. Referring now to FIG. 3, the broadcast information received by the receiver of the embodiment has been given three categories having different priority levels. Category 1 has the highest priority. Category 1, category 2, and category 3 are listed in order of decreasing precedence. The operation of the receiver of the embodiment according to the flow diagram of FIG. 2 will now be described hereunder with reference to FIG. 3.

In step 100, the controller 9 determines whether a category is specified and a channel search is instructed by the operating portion 10. If a channel search is not instructed, the step of determining, namely step 100, will be repeatedly performed. In a case where a channel search is instructed, an affirmative determination is made in step 100, and in step 101 the controller 9 sets the category to be searched for as a target, based on the user's instruction.

Next, in step 102 the controller 9 performs a channel search for a channel having a category matching the category to be searched for as a target, which is set in step 101, based on the category information (category 1) having the highest priority level among the category information which are associated with the broadcast information of each channel. For example, suppose channel 10 (CH 10) as shown in FIG. 3 is now being received, and the category “entertainment” is set as the category to be searched for as a target. The controller 9 begins to perform the channel search in order of increasing channel numbers with the channel number 10 set as an initial value.

Next, in step 103 the controller 9 determines whether a channel is found which has the category matching the category to be searched for as a target.

If a channel having the matching category is not found, in step 103 a negative determination is made, and then in step 104 the controller 9 determines whether all receivable channels have been fully searched through. If all receivable channels have not been fully searched through yet, in step 104 a negative determination is made again. In this case, returning to step 103, the channel search will be repeatedly performed.

If all receivable channels have been fully searched through, in the step 104 set forth above an affirmative determination is made, and then in step 105 the controller 9 determines whether all category information has been fully searched through. If all category information has not been fully searched through yet, in step 105 a negative determination is made, and the controller 9 performs the channel search based on the category information having the next highest priority. For example, in the case where the channel search based on the category information of category 1 has been performed, the controller 9 begins to search based on the category information having the next highest priority, namely category 2. After that, returning to step 103 set forth above, the controller 9 determines whether a channel having the matching category is found, and performs the subsequent processes repeatedly.

When a channel having a category matching the category to be searched for as a target is found, in the above-mentioned step 103 the affirmative determination is made, and then in step 107 the controller 9 receives the broadcast information of the channel having the matching category as a new channel. In the example as shown in FIG. 3, the channel in which the category information of category 1 matches the category “entertainment” to be searched for as a target is channel 14 (CH 14), which is to be received as a new channel.

Further, if the search has been completed through all category information without finding a channel having the matching category, in the above-mentioned step 105 the affirmative determination is made. And then in step 108 the controller 9 informs the user on the display 11 that there are no channels matching the category to be searched for as a target, with the result that the searching process ends.

Also, the receiver according to the present invention, upon performing the channel search with the category specified, may extract multiple channels corresponding to the specified category, display a list of the channels in order of precedence of the category information, and select a desired channel based on the list.

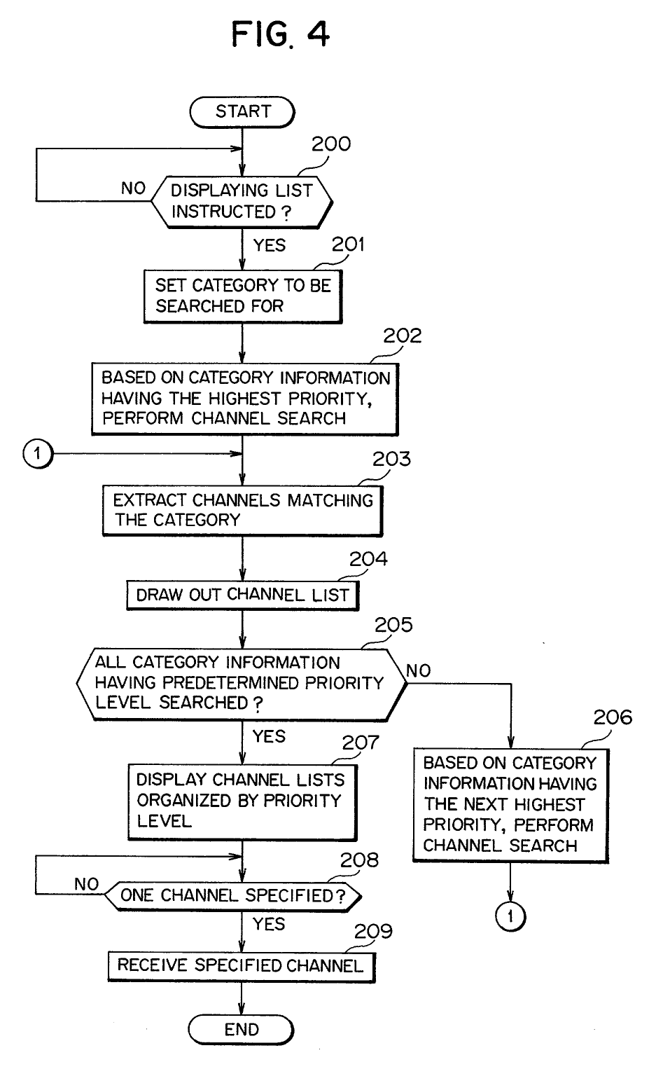

FIG. 4 is a flow diagram showing the operation of the receiver according to another embodiment upon displaying a channel search result and performing a channel search. In accordance with the flow diagram of FIG. 4, the operation of the receiver will now be described, referring to the above-mentioned FIG. 3 as one example of the category information associated with the broadcast information of each channel.

In step 200, the controller 9 determines whether a category is specified I by the operating portion 10, and an instruction to display a predetermined list is given by the operating portion 10. If displaying the predetermined list is not instructed, the step 200 is repeatedly performed.

When the instruction to display the list is given, in step 200 an affirmative determination is made, and then in step 201 the controller 9 sets a category to be searched for as a target, based on the user's operating instruction.

Next, in step 202 the controller 9 performs the channel search for channels having a category matching the category to be searched for as a target, which is set in step 201, based on the category information (category 1) having the highest priority level among the category information which are associated with the broadcast information of each channel. In step 203 the controller 9 extracts the channels having the category information matching the category to be searched for as a target.

Next, in step 204 the controller 9 draws out a predetermined channel list in which the channels extracted in step 203 are listed.

In step 205, the controller 9 determines whether the channel search has been performed through all category information having the predetermined priority levels. For instance, in this embodiment, in the case of displaying a list of the channel search result, it is possible to set in advance a scope of the search regarding what priority levels of category information are to be searched. Specifically, the following search scope can be set. The search scope (1) is for the category information of category 1 that has the highest priority level; the search scope (2) is for the category information of category 1 and category 2; and the search scope (3) is for the category information of categories 1,2 and 3.

In the case where all category information having the predetermined priority levels has not been fully searched through, in the step 205 a negative determination is made and then in step 206 the controller 9 performs the channel search based on the category information having the next highest priority level. After that, returning to the above-mentioned step 203, the processes starting with step 203 are repeatedly performed according to the flow diagram.

In the case where all category information having the predetermined priority levels has been fully searched through, in the above-mentioned step 205 an affirmative determination is made, and then in step 207 the controller 9 displays on the display 11 the channel list organized by priority.

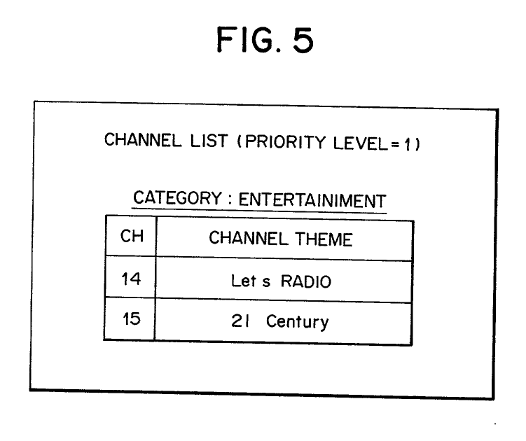

FIG. 5 is a diagram showing one example of the channel list. In this example, “entertainment” is set as a category to be searched for, and channel 14 and the channel 15 are displayed on the list, because channel 14 and channel 15 have the category information of category 1 (category information having the highest priority level) matching the category “entertainment” to be searched for as a target. If there are provided other channel lists corresponding to other priority levels, it is possible to switch and display the other channel lists corresponding to the other priority levels by using the operating portion 10 to instruct a predetermined operation instruction.

In step 208, after the channel list is displayed, the controller 9 determines whether one channel is specified by the user. When one channel is specified, the controller 9 makes an affirmative determination, and then in step 209 receives the broadcast information of the channel specified by the user, as a new channel.

As described hereinabove, according to the present invention, when the receiver receives broadcast information corresponding to a plurality of categories having different priority levels, it sets a category to be searched for as a target, and searches for the broadcast information corresponding to the category, considering the priority levels. Thus it is possible to obtain a search result satisfying the user's requirement and to effectively select the channel providing the desired broadcast information. Furthermore, the channel search result with the category specified is listed in order of precedence, thus making it possible to compare a plurality of channels considering the priority levels of the categories, whereby the desired channel can be selected with reliability.

The described embodiments of the invention are only considered to be preferred and illustrative of the inventive concept, and the scope of the invention is not restricted to such embodiments. Various other arrangements may be devised by one skilled in the art without departing from the spirit and scope of this invention. For example, in the above embodiment, when performing the channel search with the category specified and displaying the list of the search result, the priority levels of the category information that are to be searched through has been set in advance. But such a scope of the search may be set as the occasion arises. In the case of narrowing the search scope, the search result can be limited to only the category having the high priority level. On the other hand, in the case of widening the search scope, categories of all priority levels can be searched through, thus obtaining additional search results.

In the above-mentioned embodiments, the broadcast information of each channel has been provided with three pieces of category information, each having a different priority level. With respect to the number of category information, the scope of the invention is not restricted to the described embodiments.

In the above-mentioned embodiments, a receiver for receiving a digital-audio broadcast is taken as an example. The scope of the invention is not restricted to these embodiments. A receiver according to the present invention may be for receiving various kinds of broadcast including video such as BS digital broadcast, CS digital broadcast. In this case, not only an audio-signal reproducing system, but also a video-signal reproducing system may be included in the configuration of the receiver.

As described above, according to the present invention, when specifying a category to be searched for as a target and searching for broadcast information corresponding to the category, the search is performed considering the priority levels of the categories, thus making it possible to efficiently select the channel providing the desired broadcast information.

1. A receiver comprising:
a receiving unit for receiving broadcast information corresponding to a plurality of categories having different priority levels;
an input unit for identifying a category to be searched for as a target; and
a search unit for searching for the broadcast information corresponding to said category identified by said input unit, considering the priority levels.

2. The receiver according to claim 1, wherein said search unit searches through the plurality of categories corresponding to the broadcast information in order of precedence of the categories, and determines whether the searched category matches said category identified by said input unit.

3. The receiver according to claim 2, wherein said search unit determines whether the searched category matches said category identified by said input unit, in order of the channel numbers of the broadcast information.

4. The receiver according to claim 2, further comprising a search scope setting section for setting a scope of a search performed by the search unit, identifying the priority levels of categories to be searched.

5. The receiver according to claim 2, further comprising a search result displaying section for displaying a list of a search result given by the search unit in order of the precedence of the categories.

6. The receiver according to claim 5, further comprising a display scope switching section for switching a scope of the search result list displayed by said search result displaying section, and displaying the broadcast information to which priority levels of categories correspond.

7. The receiver according to claim 5, further comprising a selector for selecting desired broadcast information from the search result displayed by said search result displaying section, wherein the receiving unit receives the broadcast information selected by said selector.

8. The receiver according to claim 5, wherein said search result displaying section displays that, when the search unit fails to find the broadcast information corresponding to the category to be searched for as the target, there is no broadcast information corresponding to the category to be searched for as the target.

9. A method for searching broadcast information, the method comprising:
identifying a category to be searched for as a target; and
searching for the broadcast information corresponding to the identified category from the broadcast information corresponding to a plurality of categories having different priority levels, considering the priority levels.

10. A method for searching broadcast information, the method comprising:
identifying a category to be searched for as a target;
searching for broadcast information corresponding to the identified category from the broadcast information corresponding to a plurality of categories having different priority levels, in order of precedence of the categories; and
determining whether the searched broadcast information matches said identified category.

11. The method according to claim 10, wherein the act of determining whether the searched broadcast information matches said identified category is performed in order of the channel numbers of the broadcast information.

12. The method according to claim 10, further comprising the act of displaying a list of a search result, in order of the precedence of the categories.

13. The method according to claim 10, further comprising the acts of:
setting a scope of a search, identifying the priority levels of categories to be searched; and
searching for the broadcast information corresponding to the identified category within said scope of the search from the broadcast information corresponding to a plurality of categories having different priority levels.

14. The method according to claim 13, further comprising the act of displaying that, when the search unit fails to find the broadcast information corresponding to the category to be searched for as the target within said search scope, there is no broadcast information corresponding to the category to be searched for as the target.

15. A digital broadcast receiver comprising:
a receiving unit for receiving a digital broadcast that broadcasts by multiplexing channels, each channel corresponding to a plurality of categories having different priority levels;
an input unit for identifying a category to be searched for as a target; and
a search unit for searching for the channel corresponding to said category identified by said input unit in order of precedence of the categories, and determining whether the searched channel matches said category identified by said input unit.

16. The digital broadcast receiver according to claim 15, wherein said search unit determines whether the searched channel matches said category identified by said input unit, in order of broadcast channel numbers of the digital broadcast.

17. The digital broadcast receiver according to claim 15, further comprising a search scope setting section for setting a scope of a search performed by the search unit, identifying the priority levels of categories to be searched.

18. The digital broadcast receiver according to claim 17, further comprising a search result displaying section for displaying a list of a search result given by the search unit in order of the precedence of the categories.

19. The digital broadcast receiver according to claim 18, further comprising a selector for selecting a desired channel from the list of the search result displayed by said search result displaying section, wherein said receiving unit receives said channel selected by said selector.

20. The digital broadcast receiver according to claim 18, wherein said search result displaying section displays that, when the search unit fails to find the channel corresponding to the category to be searched for as the target, there are no channels corresponding to the category to be searched for as the target.
